(19) United States
(12) Patent Application Publication
(10) Pub. No.: US 2024/0354987 A1
(43) Pub. Date: Oct. 24, 2024

(54) APPARATUSES, METHODS, AND COMPUTER READABLE MEDIA FOR LOCALIZATION

(71) Applicant: Nokia Technologies OY, Espoo (FI)

(72) Inventors: Xiaobing LENG, Shanghai (CN); Fei GAO, Shanghai (CN); Zhihua WU, Nanchang (CN); Pengfei GUI, Shanghai (CN); Nan HU, Shanghai (CN)

(21) Appl. No.: 18/576,543

(22) PCT Filed: Jul. 16, 2021
(86) PCT No.: PCT/CN2021/106816

§ 371 Date: Jan. 4, 2024

(51) Int. Cl. G06T 7/73; G06T 7/13; G06V 40/10

(52) U.S. Cl. CPC G06T 7/74; G06T 7/13; G06V 40/10; G06T 2207/30196; G06T 2207/30244

(57) ABSTRACT

Disclosed are methods, apparatuses, and computer readable media for localization. An example apparatus may include at least one processor and at least one memory. The at least one memory may include computer program code, and the at least one memory and the computer program code may be configured to, with the at least one processor, cause the apparatus to perform determining positions of a plurality of objects of a first type to form a first polygon, determining distances between devices of a plurality of devices to form at least one second polygon, and matching the first polygon with the at least one second polygon to determine one of the at least one second polygon as a third polygon corresponding to the first polygon.

### TECHNICAL FIELD

Various embodiments relate to apparatuses, methods, and computer readable media for localization.

### BACKGROUND

Visual localization e.g. via a camera may be utilized to localize an object at a venue. For example, an electric power plant may deploy some cameras to localize a person coming into the plant, e.g. a hazardous area of the plant. However, in some venue such as the electric power plant, it is difficult to install too many cameras for localization, and in camera blind areas, far areas from cameras, or dim areas, visual localization does not work well.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is an apparatus. The apparatus may include at least one processor and at least one memory. The at least one memory may include computer program code, and the at least one memory and the computer program code may be configured to, with the at least one processor, cause the apparatus to perform determining positions of a plurality of objects of a first type to form a first polygon, determining distances between devices of a plurality of devices to form at least one second polygon, and matching the first polygon with the at least one second polygon to determine one of the at least one second polygon as a third polygon corresponding to the first polygon.

In some embodiments, differences between respective edges of the first polygon and respective edges of the third polygon may be below a threshold.

In some embodiments, the third polygon may be determined through a series of comparisons between respective edges of the first polygon and respective edges of the at least one second polygon.

In some embodiments, the at least one object of the first type may be in camera view scope, and the determining positions of the plurality of objects may include calculating coordinates of the plurality of objects in a frame through camera positioning.

In some embodiments, the first polygon and the at least one second polygon may be asymmetric.

In some embodiments, the first polygon and the at least one second polygon may be a scalene triangle.

In some embodiments, the determination of the positions of the plurality of objects may be performed synchronously with the determination of the distances between the devices of the plurality of devices.

In some embodiments, the at least one memory and the computer program code may be further configured to, with the at least one processor, cause the apparatus to further perform determining position of at least one device of the third polygon based on position of at least one object of the first polygon.

In some embodiments, the at least one memory and the computer program code may be further configured to, with the at least one processor, cause the apparatus to further perform adding the position of the at least one device of the third polygon into a database.

In some embodiments, the at least one memory and the computer program code may be further configured to, with the at least one processor, cause the apparatus to further perform tracking the position of the at least one object of the first polygon, and updating the position of the at least one device of the third polygon in the database in a case where the position of the at least one object corresponding to the at least one device changes.

In some embodiments, the at least one memory and the computer program code may be further configured to, with the at least one processor, cause the apparatus to further perform removing the positions of the devices of the third polygon from the database in a case where at least one object of the first polygon changes to be of a second type.

In some embodiments, the at least one memory and the computer program code may be further configured to, with the at least one processor, cause the apparatus to further perform removing the position of the at least one device of the third polygon from the database in a case where the at least one object corresponding to the at least one device changes to be of a second type.

In some embodiments, the at least one object of the second type may be outside camera view scope.

In some embodiments, the at least one memory and the computer program code may be further configured to, with the at least one processor, cause the apparatus to further perform selecting the position of the at least one device from the database, and determining a position of a target device based on the position of the at least one device and the distance between the target device and the at least one device.

In some embodiments, the target device may be associated with an object outside camera view scope, and the at least one device may be associated with at least one object in the camera view scope.

In some embodiments, the at least one object may be a person.

In some embodiments, the person may be identified based on a device associated with the person.

In some embodiments, the distances between the devices of the plurality of devices may be determined through device to device radio distance measurement.

In some embodiments, the distances between the devices of the plurality of devices may be determined through laser distance measurement and/or supersonic distance measurement.

In a second aspect, disclosed is a method. The method may include determining positions of a plurality of objects of a first type to form a first polygon, determining distances between devices of a plurality of devices to form at least one second polygon, and matching the first polygon with the at least one second polygon to determine one of the at least one second polygon as a third polygon corresponding to the first polygon.

In some embodiments, differences between respective edges of the first polygon and respective edges of the third polygon may be below a threshold.

In some embodiments, the third polygon may be determined through a series of comparisons between respective edges of the first polygon and respective edges of the at least one second polygon.

In some embodiments, the at least one object of the first type may be in camera view scope, and the determining positions of the plurality of objects may include calculating coordinates of the plurality of objects in a frame through camera positioning.

In some embodiments, the first polygon and the at least one second polygon may be asymmetric.

In some embodiments, the first polygon and the at least one second polygon may be a scalene triangle.

In some embodiments, the determination of the positions of the plurality of objects may be performed synchronously with the determination of the distances between the devices of the plurality of devices.

In some embodiments, the method may further include determining position of at least one device of the third polygon based on position of at least one object of the first polygon.

In some embodiments, the method may further include adding the position of the at least one device of the third polygon into a database.

In some embodiments, the method may further include tracking the position of the at least one object of the first polygon, and updating the position of the at least one device of the third polygon in the database in a case where the position of the at least one object corresponding to the at least one device changes.

In some embodiments, the method may further include removing the positions of the devices of the third polygon from the database in a case where at least one object of the first polygon changes to be of a second type.

In some embodiments, the method may further include removing the position of the at least one device of the third polygon from the database in a case where the at least one object corresponding to the at least one device changes to be of a second type.

In some embodiments, the at least one object of the second type may be outside camera view scope.

In some embodiments, the method may further include selecting the position of the at least one device from the database, and determining a position of a target device based on the position of the at least one device and the distance between the target device and the at least one device.

In some embodiments, the target device may be associated with an object outside camera view scope, and the at least one device may be associated with at least one object in the camera view scope.

In some embodiments, the at least one object may be a person.

In some embodiments, the person may be identified based on a device associated with the person.

In some embodiments, the distances between the devices of the plurality of devices may be determined through device to device radio distance measurement.

In some embodiments, the distances between the devices of the plurality of devices may be determined through laser distance measurement and/or supersonic distance measurement.

In a third aspect, disclosed is an apparatus. The apparatus may include means for determining positions of a plurality of objects of a first type to form a first polygon, means for determining distances between devices of a plurality of devices to form at least one second polygon, and means for matching the first polygon with the at least one second polygon to determine one of the at least one second polygon as a third polygon corresponding to the first polygon.

In some embodiments, differences between respective edges of the first polygon and respective edges of the third polygon may be below a threshold.

In some embodiments, the third polygon may be determined through a series of comparisons between respective edges of the first polygon and respective edges of the at least one second polygon.

In some embodiments, the at least one object of the first type may be in camera view scope, and the determining positions of the plurality of objects may include calculating coordinates of the plurality of objects in a frame through camera positioning.

In some embodiments, the first polygon and the at least one second polygon may be asymmetric.

In some embodiments, the first polygon and the at least one second polygon may be a scalene triangle.

In some embodiments, the determination of the positions of the plurality of objects may be performed synchronously with the determination of the distances between the devices of the plurality of devices.

In some embodiments, the apparatus may further include means for determining position of at least one device of the third polygon based on position of at least one object of the first polygon.

In some embodiments, the apparatus may further include means for adding the position of the at least one device of the third polygon into a database.

In some embodiments, the apparatus may further include means for tracking the position of the at least one object of the first polygon, and means for updating the position of the at least one device of the third polygon in the database in a case where the position of the at least one object corresponding to the at least one device changes.

In some embodiments, the apparatus may further include means for removing the positions of the devices of the third polygon from the database in a case where at least one object of the first polygon changes to be of a second type.

In some embodiments, the apparatus may further include means for removing the position of the at least one device of the third polygon from the database in a case where the at least one object corresponding to the at least one device changes to be of a second type.

In some embodiments, the at least one object of the second type may be outside camera view scope.

In some embodiments, the apparatus may further include means for selecting the position of the at least one device from the database, and means for determining a position of a target device based on the position of the at least one device and the distance between the target device and the at least one device.

In some embodiments, the target device may be associated with an object outside camera view scope, and the at least one device may be associated with at least one object in the camera view scope.

In some embodiments, the at least one object may be a person.

In some embodiments, the person may be identified based on a device associated with the person.

In some embodiments, the distances between the devices of the plurality of devices may be determined through device to device radio distance measurement.

In some embodiments, the distances between the devices of the plurality of devices may be determined through laser distance measurement and/or supersonic distance measurement.

In a fourth aspect, a computer readable medium is disclosed. The computer readable medium may include instructions stored thereon for causing an apparatus to perform determining positions of a plurality of objects of a first type to form a first polygon, determining distances between devices of a plurality of devices to form at least one second polygon, and matching the first polygon with the at least one second polygon to determine one of the at least one second polygon as a third polygon corresponding to the first polygon.

In some embodiments, differences between respective edges of the first polygon and respective edges of the third polygon may be below a threshold.

In some embodiments, the third polygon may be determined through a series of comparisons between respective edges of the first polygon and respective edges of the at least one second polygon.

In some embodiments, the at least one object of the first type may be in camera view scope, and the determining positions of the plurality of objects may include calculating coordinates of the plurality of objects in a frame through camera positioning.

In some embodiments, the first polygon and the at least one second polygon may be asymmetric.

In some embodiments, the first polygon and the at least one second polygon may be a scalene triangle.

In some embodiments, the determination of the positions of the plurality of objects may be performed synchronously with the determination of the distances between the devices of the plurality of devices.

In some embodiments, the computer readable medium may further include instructions stored thereon for causing an apparatus to further perform determining position of at least one device of the third polygon based on position of at least one object of the first polygon.

In some embodiments, the computer readable medium may further include instructions stored thereon for causing an apparatus to further perform adding the position of the at least one device of the third polygon into a database.

In some embodiments, the computer readable medium may further include instructions stored thereon for causing an apparatus to further perform tracking the position of the at least one object of the first polygon, and updating the position of the at least one device of the third polygon in the database in a case where the position of the at least one object corresponding to the at least one device changes.

In some embodiments, the computer readable medium may further include instructions stored thereon for causing an apparatus to further perform removing the positions of the devices of the third polygon from the database in a case where at least one object of the first polygon changes to be of a second type.

In some embodiments, the computer readable medium may further include instructions stored thereon for causing an apparatus to further perform removing the position of the at least one device of the third polygon from the database in a case where the at least one object corresponding to the at least one device changes to be of a second type.

In some embodiments, the at least one object of the second type may be outside camera view scope.

In some embodiments, the computer readable medium may further include instructions stored thereon for causing an apparatus to further perform selecting the position of the at least one device from the database, and determining a position of a target device based on the position of the at least one device and the distance between the target device and the at least one device.

In some embodiments, the target device may be associated with an object outside camera view scope, and the at least one device may be associated with at least one object in the camera view scope.

In some embodiments, the at least one object may be a person.

In some embodiments, the person may be identified based on a device associated with the person.

In some embodiments, the distances between the devices of the plurality of devices may be determined through device to device radio distance measurement.

In some embodiments, the distances between the devices of the plurality of devices may be determined through laser distance measurement and/or supersonic distance measurement.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary scenario in which the embodiments of the present disclosure may be implemented.

FIG. 2 shows a flow chart illustrating an example method for localization according to an embodiment of the present disclosure.

FIG. 3 shows a block diagram illustrating an example apparatus for localization according to an embodiment of the present disclosure.

FIG. 4 shows a block diagram illustrating an example apparatus for localization according to an embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Devices such as tags may be utilized in combination with visual localization to localize an object, for which the visual localization does not work well, e.g. a person in camera blind areas, far areas from cameras, or dim areas, according to embodiments of the present disclosure.

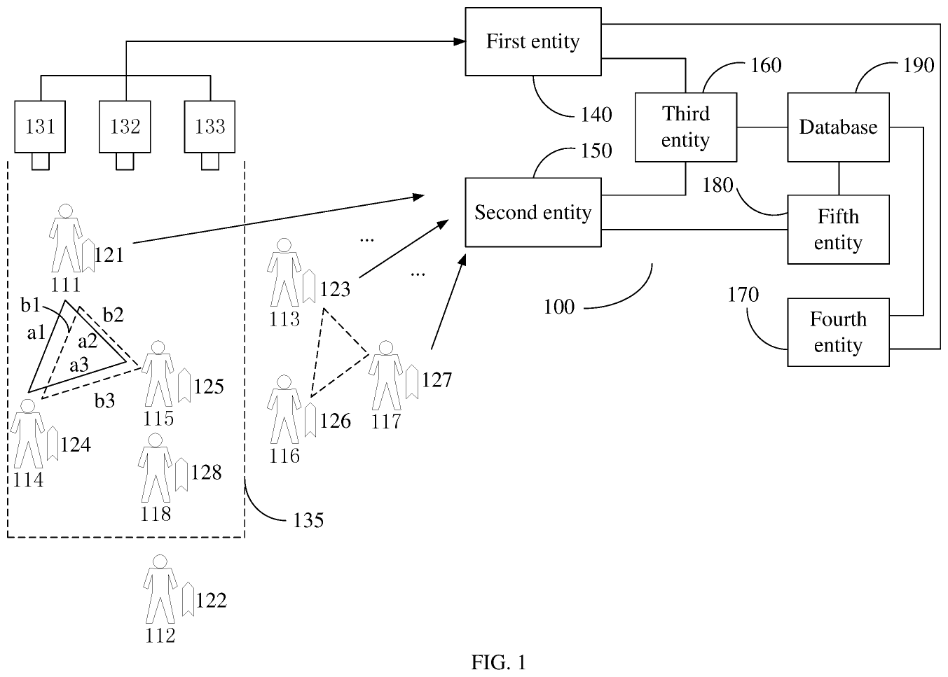

FIG. 1 shows an exemplary scenario in which the embodiments of the present disclosure may be implemented. Referring to the FIG. 1, eight objects 111 to 118 are shown as examples of objects inside a venue such as the electric power plant. It may be appreciated that more objects or less objects may be inside the venue. At least one object of the eight objects 111 to 118 may be a person, and the eight objects 111 to 118 may move independently and irregularly.

Three cameras 131 to 133 are used to observe an area 135. It may be appreciated that the three cameras 131 to 133 and the area 135 are schematic examples, for example, more cameras or less cameras may be used, the cameras may be deployed in another pattern, and the area 135 may be in a different shape. As is shown in the FIG. 1, four objects 111, 114, 115, and 118 are inside the area 135, but not all objects inside the area 135 may be observed via the cameras 131 to 133 and thus in camera view scope, for example, the object 118 may be occluded by the object 115 and thus outside the camera view scope. The objects in the camera view scope such as objects 111, 114, and 115 may be of a first type, and the objects outside the camera view scope such as objects 112, 113, 116, 117 and 118 may be of a second type. Since the objects may move, the type of the objects may change. For example, if the object 112 moves into the area 135 and is not occluded, the type of the object 112 may change to the first type, and if the object 115 leaves the area 135, the type of the object 115 may change to the second type, and the type of the object 118 may change to the first type for not being occluded by the object 115.

An apparatus 100 may perform localization for the objects in the venue according to the embodiments of the present disclosure. The apparatus 100 may comprise a first entity 140, a second entity 150, a third entity 160, a fourth entity 170, and a fifth entity 180 for performing respective operation. The first to fifth entities 140 to 180 may be different computers or servers or may be different software modules running at the apparatus 100. The apparatus 100 may be e.g. one or more servers. One server may perform the operation of one or more entities of the entities 140 to 180, and operation of one entity of the entities 140 to 180 may be performed by one or more servers.

The apparatus 100 may further comprise a database 190, and the database 190 may be separate from the one or more servers, a part of one of the one or more servers, or distributed among the one or more servers. The database 190 may be e.g. a random access memory (RAM), a file, a structured query language (SQL) database, a key/value store, a blockchain, a cloud storage, etc.

One or more cameras such as the cameras 131 to 133 may be part of the apparatus 100 or be connected and/or coupled to the apparatus 100 via a network link, and may capture images and/or visual streams to determine positions of a plurality of objects of the first type through visual localization. Alternatively or additionally, the images and/or visual streams captured by the cameras 131 to 133 may be transmitted to the first entity 140. Based on the images and/or visual streams, the first entity 140 may determine positions of the plurality of objects of the first type through visual localization. As is shown in the FIG. 1, the first entity 140 may determine positions of the objects 111, 114, and 115. The determination may comprise, for example, calculating coordinates of the plurality of objects 111, 114, and 115 in a frame through camera positioning. The frame may be e.g. an earth frame, and in this case the coordinates may be represented by latitude, longitude and altitude. Alternatively the frame may be a coordinate system for the venue such as the plant.

The first entity 140 may form a first polygon based on the determined positions of the plurality of objects 111, 114, and 115. For example, the plurality of objects 111, 114, and 115 may be at vertexes of the first polygon, respectively, and the vertexes may be labeled as 111, 114, and 115, respectively. The first entity 140 may calculate the distances between the objects of the first type based on e.g. the determined positions, which are also lengths of edges of the first polygon.

In an embodiment, the first entity 140 may form the first polygon by objects of the first type in proximity to each other, e.g. within a circle with a certain radius. For example, an object of the first type at the center of the circle and two or more adjacent objects of the first type within the radius may constitute the first polygon.

The number of edges of the first polygon may be predetermined. For example, the first polygon may be predetermined as a triangle, or a quadrangle, etc., and in this case the first entity 140 may form the triangle, or the quadrangle, etc. based on the determined positions of the plurality of objects of the first type. Alternatively, the number of edges of the first polygon may be adjusted according to the distribution of the plurality of objects of the first type. For example, in a case where some objects of the first type are in proximity e.g. within a circle with a certain radius, the number of edges of the first polygon may depend on the number of the objects of the first type in proximity. For example, if three objects of the first type are in proximity, a triangle may be formed as the first polygon, if four objects of the first type are in proximity, a quadrangle may be formed as the first polygon, etc., and it may be appreciated that more than one first polygons, e.g. the triangle and the quadrangle, may be formed meanwhile. For example, in the FIG. 1, the objects 111, 114, and 115 are shown as examples of the objects of the first type and constitute a triangle with three edges a1, a2, and a3 denoted by solid lines.

For example, assuming that in addition to the objects 111, 114, and 115, the objects 113, 116, and 117 are also in the camera view scope and thus belong to the first type, in this case in addition to the first polygon constituted by the objects 111, 114, and 115, other first polygons may be constituted by e.g. the objects 113, 116, and 117, the objects of 111, 113, and 115, or the objects 113, 115, and 116, etc. In an embodiment, the first entity 140 may optionally exclude some first polygon if at least one edge of the first polygon is above a certain distance. For example, in a case where the distance between the object 111 and the object 113 as well as the distance between the object 115 and the object 116 is above the certain distance, the first polygon constituted by the objects of 111, 113, and 115 and the first polygon constituted by the objects 113, 115, and 116 may be excluded.

The first entity 140 may transmit to the third entity 160 the at least one first polygon first polygon with information on the determined positions of the objects of the first type and the distances between the objects of the first type. In addition, the first entity 140 may track the position of at least one object of the first polygon. For example, the first entity 140 may track the position of the at least one object in the camera view scope by appearance characteristics of the at least one object, e.g. color, shape, etc., and transmit the changed position of the at least one object to the third entity 160. Tracking the position of the at least one object of the first type may include at least one repetitive operation of determining the position of the at least one object after determining the position of the at least one object. However, the first entity 140 is not necessarily to identify the objects of the first type. In other words, the first entity 140 may be not aware of identifiers of the objects constituting the first polygon.

An object may be associated with a device, e.g. a person carrying a helmet with an embedded tag, and thus the objects may be associated with the devices, respectively. The apparatus 100 may be aware of the association between the objects and the devices, e.g. the association between the identifiers of the objects and those of the devices. The objects and the associated devices may have the same or similar positions, respectively. The devices may be tags, e.g. hyper tags. As is shown in the FIG. 1, devices 121 to 128 are shown as examples of a plurality of devices, and the objects 111 to 118 may be associated with the devices 121 to 128, respectively.

A hyper tag may be for example a tag with device to device (D2D) measurement capability, and/or communication capability with a server via e.g. wireless fidelity (WiFi), new radio (NR), etc., and/or may integrate at least one sensor for a certain venue. In some cases, the hyper tag may also be e.g. a mobile phone.

The second entity 150 may determine distances between the devices of the plurality of devices. For example, the distances between the devices of the plurality of devices 121 to 128 may be determined through D2D radio distance measurement. For example, the devices 121 to 128 may use D2D channels, e.g. Bluetooth, Cellar D2D channels to detect adjacent devices and measure distances to other devices or take raw data for the second entity 150 to determine the distances. Alternatively or additionally, the distances between the devices of the plurality of devices may be determined through laser distance measurement and/or supersonic distance measurement.

The distances between the devices may be calculated by the devices and transmitted to the second entity 150. Alternatively or additionally, the devices may measure raw data, e.g. round-trip times with other devices, and/or received signal strengths from other devices. The raw data may be sent to the second entity 150, and the second entity 150 may determine the distances between the devices based on the raw data. In this case, power may be saved on the devices. However, the second entity 150 may be not aware of the exact positions of the devices.

The second entity 150 may form at least one second polygon based on the determined distances between the devices of the plurality of devices. For example, the devices 121, 124, and 125 may constitute a second polygon and be at the vertexes of the second polygon, respectively, and the devices 123, 126, and 127 may constitute another second polygon and be at the vertexes of the another second polygon, respectively. The second polygons are denoted by dash lines in the FIG. 1. And it may be appreciated that the second entity 150 may form other second polygons of the devices 121 to 128.

The second entity 150 may transmit to the third entity 160 the at least one second polygon with information on the determined distances between the devices of the plurality of devices.

The determination of the positions of the plurality of objects of the first type may be performed synchronously with the determination of the distances between the devices of the plurality of devices, e.g. both the determinations may be synchronous at a certain frequency. The synchronization of the determination of the positions of the objects and the determination of the distances between the devices may include the case that the both determinations are performed at an identical time or at timings within a predetermined time window. The first polygon and the at least one second polygon may thus be formed synchronously and the third entity 160 may receive information on the positions of the objects and information on the distances between the devices of the identical time or of the timings within a predetermined time window. In a case where the objects with the devices are in movement, the synchronization may ensure the accurate graph match between the first polygon and the at least one second polygon, which will be described later.

The third entity 160 may match the first polygon with the at least one second polygon to determine one of the at least one second polygon as a third polygon corresponding to the first polygon. The devices 121 to 128 may be carried by the objects 111 to 118, respectively, and thus the first polygon constituted by the objects of the first type, e.g. the objects 111. 114, and 115 may have one similar polygon constituted by the associated devices 121, 124, and 125 of the at least one second polygon.

In a case where the first polygon and the at least one second polygon is a triangle, there are three edges lengths of which are distances between any two vertexes. In a case where the first polygon and the at least one second polygon have four and more edges, in addition to the edges between any two vertexes, extra distances, e.g. lengths of diagonals may also be used for the graph match. Alternatively or additionally, a polygon with four and more edges maybe divided into a group of triangles, e.g. a quadrangle may be divided into two triangles, and the group of triangles may be used for the graph match.

In an embodiment, the third entity 160 may compare the length of the edge a1, which is the distance between the object 111 and the object 114, the length of the edge a2, which is the distance between the object 111 and the object 115, and the length of the edge a2, which is the distance between the object 111 and the object 115, with the lengths of respective edges of the at least one second polygon. In a case where the third entity 160 finds differences between respective edges of the first polygon and respective edges of the second polygon constituted by the device 121, 124, and 125 is below a first threshold, for example, the difference between the length of the edge a1 and the length of the edge b1, which is the distance between the device 121 and the device 124 is below the first threshold, the difference between the length of the edge a2 and the length of the edge b2, which is the distance between the device 121 and the device 125 is below the first threshold, and the difference between the length of the edge a3 and the length of the edge b3, which is the distance between the device 121 and the device 125 is below the first threshold, the second polygon constituted by the device 121, 124, and 125 may be found similar to the first polygon and may be determined as the third polygon corresponding to the first polygon.

Alternatively or additionally, the differences between respective edges may be reflected by ratios of the lengths of respective edges of the first polygon and the lengths of respective edges of the at least one second polygon. For example, the third entity 160 may calculate the ratios of the lengths of respective edges, such as (length of a1)/(length of b1), (length of a2)/(length of b2), (length of a3)/(length of b3), etc., and compare e.g. absolute values of the respective ratios minus one, e.g. |ratio−1|, with a second threshold. Then the third entity 160 may determine one of the at least one second polygon to be the third polygon in a case where the absolute values of the ratios minus one with respect to the first polygon and the second polygon are below the second threshold.

Alternatively or additionally, in a case where the first polygon and the at least one second polygon is a triangle, the third entity 160 may compare at least one edge and at least two angles of the first polygon with respective edge and angles of the at least one second polygon, or compare at least two edges and at least one angle of the first polygon with respective edges and angle of the at least one second polygon. Then the third entity 160 may determine one of the at least one second polygon to be the third polygon in a case where differences between the first polygon and the second polygon are below certain thresholds.

In a case where the third entity 160 finds more than one second polygons similar to the first polygon, for example, as is shown in the FIG. 1, in addition to the second polygon constituted by the device 121, 124, and 125, the third entity 160 finds another second polygon constituted by the devices 123, 126, and 127 similar to the first polygon, the third entity 160 may determine the third polygon through a series of comparisons between respective edges of the first polygon and respective edges of the at least one second polygon. The one or more objects may be moving and the associated one or more devices may also be moving, so the edges of the first polygon and the at least one second polygon may change, but the second polygon constituted by the devices associated with the objects constituting the first polygon may keep similar to the first polygon. For example, the second polygon constituted by the device 121, 124, and 125 may keep similar to the first polygon during the series of comparisons, but one or more other second polygons such as the second polygon constituted by the devices 123, 126, and 127 may become dissimilar to the first polygon during the series of comparisons and thus may be excluded to be the third polygon.

Assuming that in addition to the objects 111, 114, and 115, the objects 113, 116, and 117 are also in the camera view scope and thus are of the first type, in this case in addition to the first polygon constituted by the objects 111, 114, and 115, another first polygon may be constituted by the objects 113, 116, and 117. Assuming that at some moment the first polygon constituted by the objects 111, 114, and 115 and the another first polygon constituted by the objects 113, 116, and 117 are similar, for the first polygon, the third entity 160 may find e.g. two second polygons constituted by the device 121, 124, and 125, and constituted by the devices 123, 126, and 127 respectively are similar, and for the another first polygon, the third entity 160 may also find two second polygons constituted by the device 121, 124, and 125, and constituted by the devices 123, 126, and 127 respectively are similar. With the independent and/or irregular movements of the one or more objects, during the respective series of comparisons with respect to the first polygon and with respect to the another first polygon, the second polygon constituted by the device 121, 124, and 125 may keep similar to the first polygon and the second polygon constituted by the devices 123, 126, and 127 may become dissimilar to the first polygon, and the second polygon constituted by the device 123, 126, and 127 may keep similar to the another first polygon, and the second polygon constituted by the devices 121, 124, and 125 may become dissimilar to the another first polygon.

Additionally, the third entity 160 may determine whether the first polygon and the at least one second polygon is asymmetric and perform the graph match between the first polygon and the at least one second polygon in a case where the first polygon and the at least one second polygon is asymmetric. In an embodiment, the third entity 160 may determine whether the first polygon and the at least one second polygon is a scalene triangle and perform the graph match between the first polygon and the at least one second polygon in a case where the first polygon and the at least one second polygon is a scalene triangle. Alternatively, the third entity 160 may determine whether the third polygon is asymmetric and/or a scalene triangle. The asymmetric polygon may be neither a line symmetry polygon nor a point symmetry polygon.

For example, the third entity 160 may compare differences between the edges of the first polygon, the at least one second polygon, and/or the third polygon with a third threshold and may determine the first polygon, the at least one second polygon, and/or the third polygon to be asymmetric and/or a scalene triangle in a case where the differences between the edges of the first polygon, the at least one second polygon, and/or the third polygon are above the third threshold.

Alternatively or additionally, the third entity 160 may calculate ratios of lengths of the edges of the first polygon, the at least one second polygon, and/or the third polygon, e.g. (length of a1)/(length of a2) and (length of a1)/(length of a3) as well as (length of b2)/(length of b1) and (length of b3)/(length of b2), etc., and compare e.g. absolute values of the respective ratios minus one, e.g. |ratio−1|, with a fourth threshold. Then the third entity 160 may determine the first polygon, the at least one second polygon, and/or the third polygon to be asymmetric and/or a scalene triangle in a case where the absolute values of the ratios minus one with respect to the first polygon, the at least one second polygon, and/or the third polygon are above the fourth threshold.

In a case where the first polygon, the at least one second polygon, and/or the third polygon is asymmetric and/or a scalene triangle, the vertexes of the first polygon may correspond to the vertexes of the third polygon, respectively. This may facilitate the third entity 160 to determine position of at least one device of the third polygon based on position of at least one object of the first polygon.

The third entity 160 may be aware of the positions of the objects of the first polygon and the corresponding relationship between the vertexes of the first polygon and the vertexes of the third polygon, the third entity 160 may determine position of at least one device of the third polygon based on position of the corresponding at least one object of the first polygon. For example, as is shown in the FIG. 1, in a case where the third polygon constituted by the devices 121. 124, and 125 is determined, and the devices 121, 124, and 125 correspond to the vertexes of the first polygon, the third entity 160 may determine the position of at least one device of the devices 121, 124, and 125 based on the position of the corresponding at least one object of the first polygon. Based on the association between the devices and the objects, in addition to the positions of the respective objects constituting the first polygon, the third entity 160 may be aware of the identifiers of the respective objects. The third polygon with the vertexes may be used as a beacon polygon or a reference polygon for localizing an object of the second type.

In an embodiment, the third entity 160 may add the position of the at least one device of the third polygon into the database 190 which may be dynamically maintained by the fourth entity 170.

In an embodiment, the apparatus 100 may determine positions of one or more objects within camera view scope and corresponding positions of one or more devices associated with the one or more objects respectively. The apparatus 100 may further determine a position of a device by utilizing the determined positions of the one or more devices. The apparatus 100 may use known positioning methods such as triangulation between the one more devices and the device. The one or more devices may determine the position of the device and send the determined position to the apparatus 100 over communication networks. In another embodiment, the one or more devices send one or more measurements in relation to the device, e.g. radio signal strength, to the apparatus 100 over communication networks, and the apparatus 100 process the one or more measurements, e.g. using triangulation, to determine the position of the device. In one embodiment, the device is associated with an object, which is not in camera view scope.

As is mentioned above, the first entity 140 may track the position of the at least one object of the first polygon and transmit the changed position of the at least one object of the first polygon to the fourth entity 170. And the fourth entity 170 may update the position of the at least one device of the third polygon in the database 190 in a case where the position of the at least one object corresponding to the at least one device changes. For example, the fourth entity 170 may find in the database 190 the device corresponding to the object with changed position based on the corresponding relation between the device and the vertex of the first polygon, which may be tracked through the track of the object. Alternatively or additionally, the first entity 140 may receive a feedback from the third entity 160 including the identifiers of the objects of the first polygon after the third polygon corresponding to the first polygon is determined, such that the first entity 140 may notify the fourth entity 170 of the changed position of the object with the identifier and the fourth entity 170 may find in the database 190 the device corresponding to the object with the changed position. Thus the fourth entity 170 may update the position of the at least one device of the third polygon in the database 190 based on the changed position of the associated at least one object.

In a case where the first entity 140 does not track the position of the at least one object of the first polygon and/or does not transmit the changed position of the at least one object of the first polygon to the fourth entity 170. The fourth entity 170 may keep the position of the at least one device of the third polygon in the database 190 for a holding time. In a case where the object does not have large movement at a short time, the holding time may be set to a short time, e.g. 300 milliseconds. When the holding time expires, the fourth entity 170 may remove the position of the at least one device of the third polygon from the database 190 or may remove the positions of the devices of the third polygon from the database 190.

An object of the first polygon may change to be of the second type. For example, at least one object of the first polygon may leave and thus disappear from the camera view scope. In this case, the first entity 140 may transmit to the fourth entity 170 an indication indicating that the at least one object changes to be of the second type. Then the fourth entity 170 may find in the database 190 the at least one device corresponding to the at least one object changing to be of the second type. For example, the fourth entity 170 may find the at least one device based on the corresponding relation between the at least one device of the third polygon and the at least one vertex of the first polygon, which may be found disappear by the first entity 140. Alternatively or additionally, the first entity 140 may receive a feedback from the third entity 160 including the identifiers of the objects of the first polygon after the third polygon corresponding to the first polygon is determined, and in this case the first entity 140 may notify the fourth entity 170 of the disappeared at least one object with the identifier, such that the fourth entity 170 may find in the database 190 the at least one device corresponding to the disappeared at least one object.

The fourth entity 170 may remove the positions of the devices of the third polygon from the database 190 in a case where the at least one object of the first polygon changes to be of the second type. For example, in this case the fourth entity 170 may remove the positions of the devices of the third polygon including the at least one device corresponding to the disappeared at least one object from the database 190.

Alternatively, the fourth entity 170 may remove the position of the at least one device of the third polygon from the database 190 in a case where the at least one object corresponding to the at least one device changes to be of a second type. For example, in this case the fourth entity 170 may remove the position of the at least one device corresponding to the disappeared at least one object from the database 190 and keep the position of at least one other device of the third polygon in the database 190.

The fourth entity 170 may thus dynamically maintain the database 190 to store current position of the at least one device associated with the at least one object in the camera view scope.

Referring to the FIG. 1, the fifth entity 180 may determine a position of a device as a target device associated with an object outside the camera view scope such as the objects 112. 113, 116, 117, and 118, and thus localize and identify the object outside the camera view scope. The fifth entity 180 may also localize a device as a target device not associated with an object.

The fifth entity 180 may select the position of the at least one device from the database 190 and determine the position of the target device based on the position of the at least one device and the distance between the target device and the at least one device. The distance between the target device and the at least one device may be received from the second entity 150.

In an embodiment, the fifth entity 180 may select from the database 190 the position of one device with a minimum distance to the target device. If the distance between the target device and the selected one device is below a fifth threshold e.g. 1 meter, 0.5 meter, etc., the position of the selected one device may be determined as the position of the target device. For example, as is shown in the FIG. 1, the object 118 is in proximity to and occluded by the object 115. Assuming that the target device is the device 128 associated with the object 118, the fifth entity 180 may select the position of the device 125 which is with the minimum distance to the device 128 in the database 190, and the position of the device 125 may be determined as the position of the target device 128 if the distance between the device 125 and the target device 128 is below the fifth threshold. Alternatively, in a case where the fifth entity 180 finds in the database 190 a plurality of devices with distances to the target device 128 below the fifth threshold, the fifth entity 180 may determine the position of any one device of the plurality of devices as the position of the target device 128.

Alternatively or additionally, the fifth entity 180 may select the positions of the at least two devices from the database 190. The selected at least two devices may optionally be the at least two devices with minimum two distances to the target device. Alternatively, the selected at least two devices may be any at least two devices in the database 190. Alternatively, the selected at least two devices may be any at least two devices within a certain distance to the target device. The at least two devices may be from one third polygon or be from different third polygons.

In a case where positions of three or more devices are selected from the database 190, the position of the target device may be determined through triangulation. In a case where positions of two devices are selected from the database 190, two possible positions of the target device may be determined through triangulation, and the position which is less likely to be the position of the target device may be excluded. Thus, the position of the object associated with the target device may be determined.

Alternatively or additionally, in a case where the positions of the at least two devices are selected from the database 190, intersections formed during the triangulation may be determined as possible positions of the target device, and if at least one possible position is located within e.g. a hazardous area, the object associated with the target device may be determined within the hazardous area. In this case the exact position of the target device may not necessarily be determined.

According to the embodiments of the present disclosure, as the visual localization does not have multi-path problem and thus may have relative high localization accuracy, the localization of devices based on the visual localization may have relative high localization accuracy. In addition, as a device associated with an object outside the camera view scope, e.g. in camera blind areas, far areas from cameras, or dim areas may be localized, not so many cameras need to be used. In addition, an object may be in movement, and a moving device may be used as reference point for localization, and thus fixed anchor node may be not necessary.

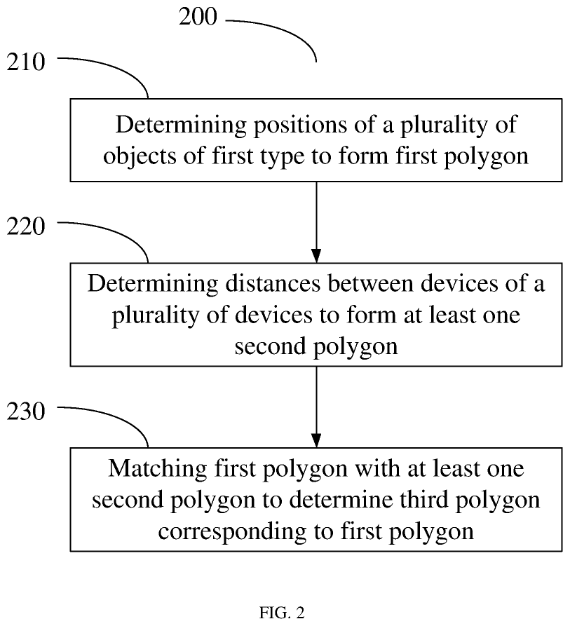

FIG. 2 shows a flow chart illustrating an example method 200 for localization according to an embodiment of the present disclosure. The example method 200 may be performed for example at one or more servers such as the apparatus 100.

Referring to the FIG. 2, the example method 200 may include an operation 210 of determining positions of a plurality of objects of a first type to form a first polygon, an operation 220 of determining distances between devices of a plurality of devices to form at least one second polygon, and an operation 230 of matching the first polygon with the at least one second polygon to determine one of the at least one second polygon as a third polygon corresponding to the first polygon.

Details of the operation 210 may refer to the above descriptions with respect to at least the first entity 140 and the cameras 131 to 133, and repetitive descriptions thereof are omitted here.

Details of the operation 220 may refer to the above descriptions with respect to at least the second entity 150 and the devices 121 to 128, and repetitive descriptions thereof are omitted here.

Details of the operation 230 may refer to the above descriptions with respect to at least the third entity 160, and repetitive descriptions thereof are omitted here.

In an embodiment, differences between respective edges of the first polygon and respective edges of the third polygon may be below a threshold. The more details may refer to the above descriptions with respect to at least the third entity 160, and repetitive descriptions thereof are omitted here.

In an embodiment, the third polygon may be determined through a series of comparisons between respective edges of the first polygon and respective edges of the at least one second polygon. The more details may refer to the above descriptions with respect to at least the third entity 160, and repetitive descriptions thereof are omitted here.

In an embodiment, the at least one object of the first type may be in camera view scope, and the determining positions of the plurality of objects may include calculating coordinates of the plurality of objects in a frame through camera positioning. The more details may refer to the above descriptions with respect to at least the cameras 131 to 133, the objects 111, 114, and 115, and the first entity 140, and repetitive descriptions thereof are omitted here.

In an embodiment, the first polygon and the at least one second polygon may be asymmetric. The more details may refer to the above descriptions with respect to at least the third entity 160, and repetitive descriptions thereof are omitted here.

In an embodiment, the first polygon and the at least one second polygon may be a scalene triangle. The more details may refer to the above descriptions with respect to at least the third entity 160, and repetitive descriptions thereof are omitted here.

In an embodiment, the determination of the positions of the plurality of objects may be performed synchronously with the determination of the distances between the devices of the plurality of devices. The more details may refer to the above descriptions with respect to at least the first entity 140 and the second entity 150, and repetitive descriptions thereof are omitted here.

In an embodiment, the example method 200 may further include an operation of determining position of at least one device of the third polygon based on position of at least one object of the first polygon. The more details may refer to the above descriptions with respect to at least the third entity 160, and repetitive descriptions thereof are omitted here.

In an embodiment, the example method 200 may further include an operation of adding the position of the at least one device of the third polygon into a database. The more details may refer to the above descriptions with respect to at least the third entity 160 and the database 190, and repetitive descriptions thereof are omitted here.

In an embodiment, the example method 200 may further include an operation of tracking the position of the at least one object of the first polygon, and updating the position of the at least one device of the third polygon in the database in a case where the position of the at least one object corresponding to the at least one device changes. The more details may refer to the above descriptions with respect to at least the first entity 140, the fourth entity 170, and the database 190, and repetitive descriptions thereof are omitted here.

In an embodiment, the example method 200 may further include an operation of removing the positions of the devices of the third polygon from the database in a case where at least one object of the first polygon changes to be of a second type. The more details may refer to the above descriptions with respect to at least the first entity 140, the fourth entity 170, and the database 190, and repetitive descriptions thereof are omitted here.

In an embodiment, the example method 200 may further include an operation of removing the position of the at least one device of the third polygon from the database in a case where the at least one object corresponding to the at least one device changes to be of a second type. The more details may refer to the above descriptions with respect to at least the first entity 140, the fourth entity 170, and the database 190, and repetitive descriptions thereof are omitted here.

In an embodiment, the at least one object of the second type is outside camera view scope. The more details may refer to the above descriptions with respect to at least the cameras 131 to 133, and the objects 112. 113, 116, 117, and 118, and repetitive descriptions thereof are omitted here.

In an embodiment, the example method 200 may further include an operation of selecting the position of the at least one device from the database, and an operation of determining a position of a target device based on the position of the at least one device and the distance between the target device and the at least one device. The more details may refer to the above descriptions with respect to at least the second entity 150, the fifth entity 180, and the database 190, and repetitive descriptions thereof are omitted here.

In an embodiment, the target device may be associated with an object outside camera view scope, and the at least one device may be associated with at least one object in the camera view scope. The more details may refer to the above descriptions with respect to at least the devices 121 to 128, and repetitive descriptions thereof are omitted here.

In an embodiment, the at least one object may be a person. The more details may refer to the above descriptions with respect to at least the objects 111 to 118, and repetitive descriptions thereof are omitted here.

In an embodiment, the person may be identified based on a device associated with the person. The more details may refer to the above descriptions with respect to at least the objects 111 to 118 and the devices 121 to 128, and repetitive descriptions thereof are omitted here.

In an embodiment, the distances between the devices of the plurality of devices may be determined through device to device radio distance measurement. The more details may refer to the above descriptions with respect to at least the devices 121 to 128 and the second entity 150, and repetitive descriptions thereof are omitted here.

In an embodiment, the distances between the devices of the plurality of devices may be determined through laser distance measurement and/or supersonic distance measurement. The more details may refer to the above descriptions with respect to at least the devices 121 to 128 and the second entity 150, and repetitive descriptions thereof are omitted here.

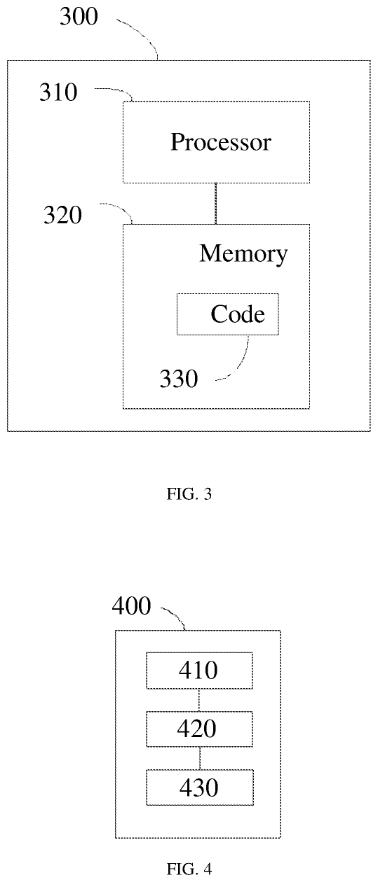

FIG. 3 shows a block diagram illustrating an example apparatus for localization according to an embodiment of the present disclosure. The apparatus, for example, may be at least part of the apparatus 100 in the above examples.

As shown in the FIG. 3, the example apparatus 300 may include at least one processor 310 and at least one memory 320 that may include computer program code 330. The at least one memory 320 and the computer program code 330 may be configured to, with the at least one processor 310, cause the apparatus 300 at least to perform the example method 200 described above.

In various example embodiments, the at least one processor 310 in the example apparatus 300 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 410 may also include at least one other circuitry or element not shown in the FIG. 3.

In various example embodiments, the at least one memory 320 in the example apparatus 300 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 320 may include, but are not limited to, an electric, a magnetic, an optical, an electromagnetic, an infrared, or a semiconductor system, apparatus, or device or any combination of the above.

Further, in various example embodiments, the example apparatus 300 may also include at least one other circuitry, element, and interface, for example at least one I/O interface, at least one antenna element, and the like.

In various example embodiments, the circuitries, parts, elements, and interfaces in the example apparatus 300, including the at least one processor 310 and the at least one memory 320, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus as at least part of the apparatus 100 is not limited to the above example apparatus 300.

FIG. 4 shows a block diagram illustrating an example apparatus for localization according to an embodiment of the present disclosure. The apparatus, for example, may be at least part of the apparatus 100 in the above examples.

As shown in FIG. 4, the example apparatus 400 may include means 410 for performing the operation 210 of the example method 200, means 420 for performing the operation 220 of the example method 200, and means 430 for performing the operation 230 of the example method 200. In one or more another example embodiments, at least one I/O interface, at least one antenna element, and the like may also be included in the example apparatus 400.

In some example embodiments, examples of means in the example apparatus 400 may include circuitries. For example, an example of means 410 may include a circuitry configured to perform the operation 210 of the example method 200, an example of means 420 may include a circuitry configured to perform the operation 220 of the example method 200, and an example of means 430 may include a circuitry configured to perform the operation 230 of the example method 200. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and acts of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
D2D device to device
NR new radio
RAM random access memory
SQL structured query language
WiFi wireless fidelity

1-40. (canceled)

41. An apparatus comprising:
at least one processor; and
at least one memory comprising computer program code, the at least one memory and the computer program code being configured to, with the at least one processor, cause the apparatus to perform:
determining positions of a plurality of objects of a first type to form a first polygon;
determining distances between devices of a plurality of devices to form at least one second polygon; and
matching the first polygon with the at least one second polygon to determine one of the at least one second polygon as a third polygon corresponding to the first polygon.

42. The apparatus of claim 41, wherein differences between respective edges of the first polygon and respective edges of the third polygon are below a threshold.

43. The apparatus of claim 42, wherein the third polygon is determined through a series of comparisons between respective edges of the first polygon and respective edges of the at least one second polygon.

44. The apparatus of claim 41, wherein the at least one object of the first type is in camera view scope, and the determining positions of the plurality of objects comprises calculating coordinates of the plurality of objects in a frame through camera positioning.

45. The apparatus of claims 41, wherein the first polygon and the at least one second polygon are asymmetric.

46. The apparatus of claim 41, wherein the first polygon and the at least one second polygon are scalene triangles.

47. The apparatus of claim 41, wherein the determination of the positions of the plurality of objects is performed synchronously with the determination of the distances between the devices of the plurality of devices.

48. The apparatus of claim 41, the at least one memory and the computer program code are further configured to, with the at least one processor, cause the apparatus to further perform:
determining position of at least one device of the third polygon based on position of at least one object of the first polygon.

49. The apparatus of claim 48, the at least one memory and the computer program code are further configured to, with the at least one processor, cause the apparatus to further perform:
adding the position of the at least one device of the third polygon into a database.

50. The apparatus of claim 49, the at least one memory and the computer program code are further configured to, with the at least one processor, cause the apparatus to further perform:
tracking the position of the at least one object of the first polygon; and
updating the position of the at least one device of the third polygon in the database in a case where the position of the at least one object corresponding to the at least one device changes.

51. The apparatus of claim 49, the at least one memory and the computer program code are further configured to, with the at least one processor, cause the apparatus to further perform:
removing the positions of the devices of the third polygon from the database in a case where at least one object of the first polygon changes to be of a second type.

52. The apparatus of claim 49, the at least one memory and the computer program code are further configured to, with the at least one processor, cause the apparatus to further perform:
removing the position of the at least one device of the third polygon from the database in a case where the at least one object corresponding to the at least one device changes to be of a second type.

53. The apparatus of claim 51, wherein the at least one object of the second type is outside camera view scope.

54. The apparatus of claim 49, the at least one memory and the computer program code are further configured to, with the at least one processor, cause the apparatus to further perform:
selecting the position of the at least one device from the database; and
determining a position of a target device based on the position of the at least one device and the distance between the target device and the at least one device.

55. The apparatus of claim 54, wherein the target device is associated with an object outside camera view scope, and the at least one device is associated with at least one object in the camera view scope.

56. The apparatus of claim 41, wherein the at least one object is a person.

57. The apparatus of claim 56, wherein the person is identified based on a device associated with the person.

58. The apparatus of claim 41, the distances between the devices of the plurality of devices are determined through device-to-device radio distance measurement.

59. The apparatus of claim 41, the distances between the devices of the plurality of devices are determined through laser distance measurement and/or supersonic distance measurement.

60. A method comprising:
determining positions of a plurality of objects of a first type to form a first polygon;
determining distances between devices of a plurality of devices to form at least one second polygon; and
matching the first polygon with the at least one second polygon to determine one of the at least one second polygon as a third polygon corresponding to the first polygon.
